(19) United States
(12) Patent Application Publication
(10) Pub. No.: US 2024/0329267 A1
(43) Pub. Date: Oct. 3, 2024

(54) GEOLOGIC INTERPRETATION METHOD AND SYSTEM BASED ON VISION-LANGUAGE MODEL

(71) Applicant: CGG SERVICES SAS, Massy Cedex (FR)

(72) Inventor: Song HOU, Crawley (GB)

(21) Appl. No.: 18/610,814

(22) Filed: Mar. 20, 2024

Related U.S. Application Data
(60) Provisional application No. 63/492,349, filed on Mar. 27, 2023.

(51) Int. Cl. G01V 1/34

(52) U.S. Cl. CPC G01V 1/345

(57) ABSTRACT

A method for delineating geological features of a surveyed subsurface with a vision-language model, VLM, the method including receiving verbal and/or written descriptions of the geological features, from a user, converting the verbal and/or written descriptions into interpretable input data using a large language model, LLM, configuring a pretrained VLM, based on the interpretable input data and geological images of another subsurface, to obtain a tailored VLM, and delineating with the tailored VLM, the geological features in an image of the subsurface, which is generated based on input seismic data d acquired over the subsurface.

### BACKGROUND OF THE INVENTION

### Technical Field

Embodiments of the subject matter disclosed herein generally relate to a system and method for processing recorded seismic data for extracting information related to one or more formations (e.g., geological feature) in the subsurface, and more particularly, to using a vision-language model for geological interpretation of the subsurface using minimal supervision.

### Discussion of the Background

Hydrocarbon exploration and development uses waves (e.g., seismic waves or electromagnetic waves) to explore the structure of underground formations on land and/or at sea (i.e., formations under the seafloor). As schematically illustrated in FIG. 1, a marine acquisition system (the description of a land based acquisition system follows the same principles) includes a source 110 and at least one sensor 130. Waves emitted by the source 110 at a known location penetrate an explored subsurface 120 and are reflected, refracted or diffracted at interfaces 112, 122, 124, and 126 that separate the subsurface's layers or formations 121, 123, 125, and 127 having different layer properties. Sensors 130 (only one is shown for simplicity), which may be towed by a vessel 132 on streamers (not shown), or may be independently placed in the water or ocean bottom (not shown), detect the waves and record one or more of their characteristics, for example, pressure, one-dimensional displacement, three-dimensional displacement, speed, acceleration, etc. Note that, as used herein, the term “formation” refers to any geophysical structure into which source energy is injected to perform seismic surveying, e.g., land, ocean bottom, transition zone, or marine based. This means that the configuration shown in FIG. 1 may also be used on land, in which case the source 110 is carried by a truck or other means, from one point to another, and the sensors 130 are located on the surface, or buried in the subsurface. Note that the sensors 130 are known in the art and they can include hydrophones, accelerometers, geophones, gravitational sensors, electromagnetic sensors, etc.

Various geological features (also called “bodies,” for example, faults, channels, etc.) may be present in the subsurface 120 and the target of the seismic data processing is to determine the location, borders, and/or characteristics of these bodies. For example, a geological body that is indicative of an oil and gas reservoir is the fault. A fault refers to a geological discontinuity or fracture in subsurface rock formations that can affect the behavior of seismic waves as they propagate through the Earth. Faults can have significant implications for oil and gas exploration and production because they can act as barriers or conduits to fluid flow within reservoirs.

When seismic waves encounter a fault during seismic data acquisition, they may reflect, refract, or diffract, leading to changes in the seismic data recorded at the surface or downhole. These changes can manifest as amplitude anomalies, time delays, or other seismic signatures that indicate the presence of a fault. Geologists use seismic data analysis techniques, such as seismic interpretation and seismic attribute analysis, to identify and characterize faults in subsurface reservoirs. Understanding the location, orientation, and properties of faults is important for accurately mapping and modeling subsurface structures, predicting reservoir behavior, and optimizing drilling and production strategies in oil and gas exploration and production operations.

In order to understand the structure of the explored underground formation or geological bodies (e.g., layers 121, 123, 125, and 127 and interfaces 112, 122, 124, and 126 in the specific example of FIG. 1), various steps are performed on the seismic data “d” recorded by sensors 130, as part of the processing (e.g., migration, stacking, full wavelength inversion) of the recorded seismic data. In the past, these steps, although performed on a computer, required full involvement of the geologist. However, more recently, machine learning (ML) algorithms were implemented to analyze the seismic data, which require less involvement from a geologist.

More specifically, as illustrated in FIG. 2, an ML-based workflow 200 for identifying geological features in the subsurface starts in step 202 with selecting the ML model, for example, a deep learning model. A deep learning model may be a convolutional neural network (CNN) for image processing. As the CNN is typically not trained for identifying geological bodies, a training step 204 is performed. This step requires a large amount of the geologist's time as samples of known (labeled) geological features need to be fed to the CNN. After the CNN is trained, the seismic data for a region of interest is received in step 208 and applied to the trained CNN. The trained CNN identifies in step 210 various geological features in the subsurface.

However, this CNN-based method still makes the seismic imaging and interpretation a challenging task. Such a traditional workflow for interpreting geobodies requires a time-consuming collaborative effort between skilled geophysicists and geologists for the training step 206. Training a generalized DNN model requires a large number of high-quality labels. It is time-consuming to manually pick accurate labels for the geobodies of interest. Lack of training data is a common challenge in developing deep learning models in the geological domain. This is because it is often expensive and time-consuming to acquire such data. Therefore, the entire process can take still take weeks or even months, depending on the imaging area size.

Thus, there is a need for a new workflow to detect geobodies of interest from seismic data and to overcome the above noted problems.

### SUMMARY OF THE INVENTION

According to an embodiment, there is a method for delineating geological features of a surveyed subsurface with a vision-language model, VLM, and the method includes receiving verbal and/or written descriptions of the geological features, from a user, converting the verbal and/or written descriptions into interpretable input data using a large language model, LLM, configuring a pretrained VLM, based on the interpretable input data and geological images of another subsurface, to obtain a tailored VLM, and delineating with the tailored VLM, the geological features in an image of the subsurface, which is generated based on input seismic data d acquired over the subsurface.

According to another embodiment, there is a method for delineating geological features of a surveyed subsurface, with a vision-language model, VLM, the method including receiving verbal and/or written descriptions of the geological features, from a user, and delineating with a tailored VLM or a pretrained VLM, the geological features in a seismic image of the subsurface, generated based on input seismic data d of the subsurface.

According to yet another embodiment, there is a device for detecting geological features associated with seismic data d, and the device includes a processor implementing a pretrained visual-language model, VLM, or a tailored VLM, which is trained with verbal and/or written descriptions and geological images associated with a first subsurface, which not associated with the seismic data d, and an interface connected to the processor and configured to receive the seismic data d, which is associated with a second subsurface. The processor is configured to receive verbal and/or written descriptions of the geological features, from a user, and delineate with the tailored VLM or the pretrained VLM, the geological features in an image of the second subsurface, based on the seismic data d acquired over the second subsurface.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a marine based seismic acquisition system;

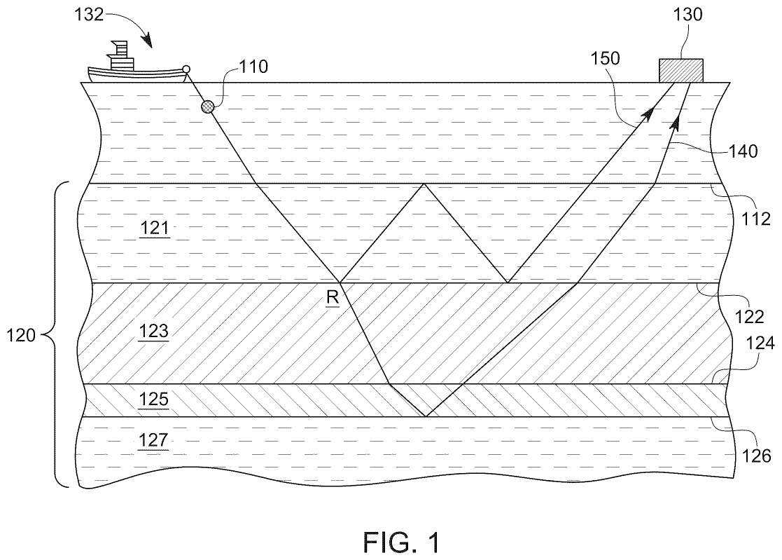

FIG. 2 is a schematic flow chart of a method that uses machine learning for learning geological features in seismic data and then the trained machine learning is used on new seismic data for delineating similar geological features;

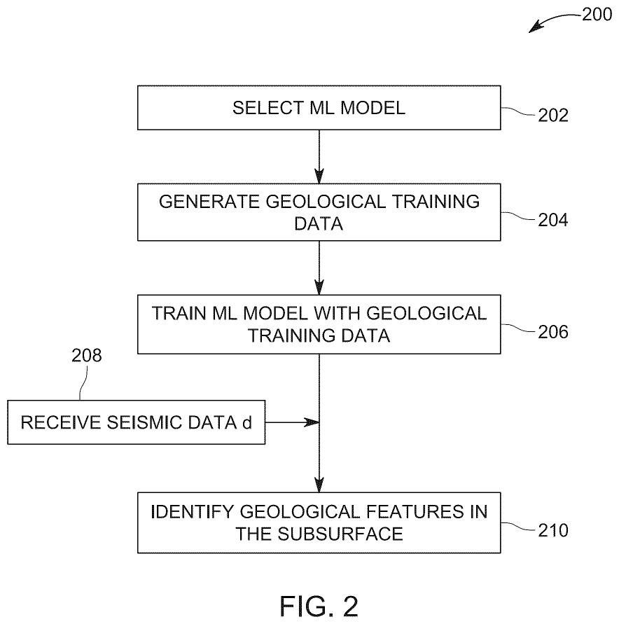

FIG. 3 is a schematic flow chart of a method that uses a vision-language model that handles as input both text and image prompts and is used for delineating geological features with no or minimum training;

FIG. 4 schematically illustrates how the vision-language model is tailored for the geological field;

FIG. 5 schematically illustrates how the vision-language model is used for delineating geological features from seismic data;

FIG. 6 is a schematic diagram of a computing device that is configured to implement the methods discussed herein;

FIG. 7 is a schematic diagram illustrating how the various components of the vision-language model are mapped onto the computing device of FIG. 6; and

FIG. 8 is a flow chart of a method of delineating geological features in acquired seismic data based on the vision-learning model.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed with regard to a vision-language model for determining the location of geologic features in a subsurface, using terminology of seismic data processing. However, the embodiments to be discussed next are not limited to seismic data, but may be applied to other types of data, for example, electromagnetic wave data or acoustic data or medical data. Also, the embodiments discussed herein are not limited to applying the vision-language model, but may use a combination of models, for example, a vision transformer and a large language model.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a system and method employ vision-language models for the interpretation of geological features in geophysical data, significantly reducing the need for extensive human intervention. Vision-language models represent an innovative fusion of computer vision and natural language processing technologies. These models are adept at processing and interpreting (geophysical) data alongside their corresponding textual descriptions, creating a robust framework for understanding and analyzing complex geological features and structures.

A vision-language model is an integrated system combining the capabilities of vision and natural language models. This model operates by ingesting images and their respective textual descriptions, and learns to correlate and interpret information from both visual and linguistic inputs. The vision component of the model is configured to capture spatial and textural features from images, while the language component encodes textual data, deriving meaning and context. This dual-modality approach allows the model to map data across both visual and textual domains. For example, the model can match a geological feature such as a fault or channel, with the correct words or explanations. Similarly, the text helps the model to identify specific features in supplied geological data.

One example of a vision-language model is the Vision-Language Pre-training (VLP) model (see, for example, a survey of VLP models at doi.org/10.48550/arXiv.2210.09263), which is a class of multi-modal models developed for tasks such as image captioning, visual question answering (VQA), and image-text matching. These models are typically based on architectures like Transformers, which have shown remarkable success in natural language processing (NLP) tasks, and they incorporate mechanisms for processing both visual and textual inputs.

The VLP works according to the following procedure. The model is pre-trained on a large dataset containing pairs of images and corresponding text descriptions or captions. During pre-training, the model learns to encode both the visual and textual information into a shared representation space. Note that such models are pretrained for other purposes than geological interpretations and thus, they are readily available on the market but they likely had no exposure to seismic data. After pre-training, the model can be fine-tuned on specific downstream tasks. For example, it can be fine-tuned on tasks like geological interpretation, where the model is given one or more images and asked to generate a relevant geological feature, for example, a fault. Once trained, the model can be used to generate geological features for new seismic data, answer questions about unseen images, or perform other tasks that require understanding both visual and textual information.

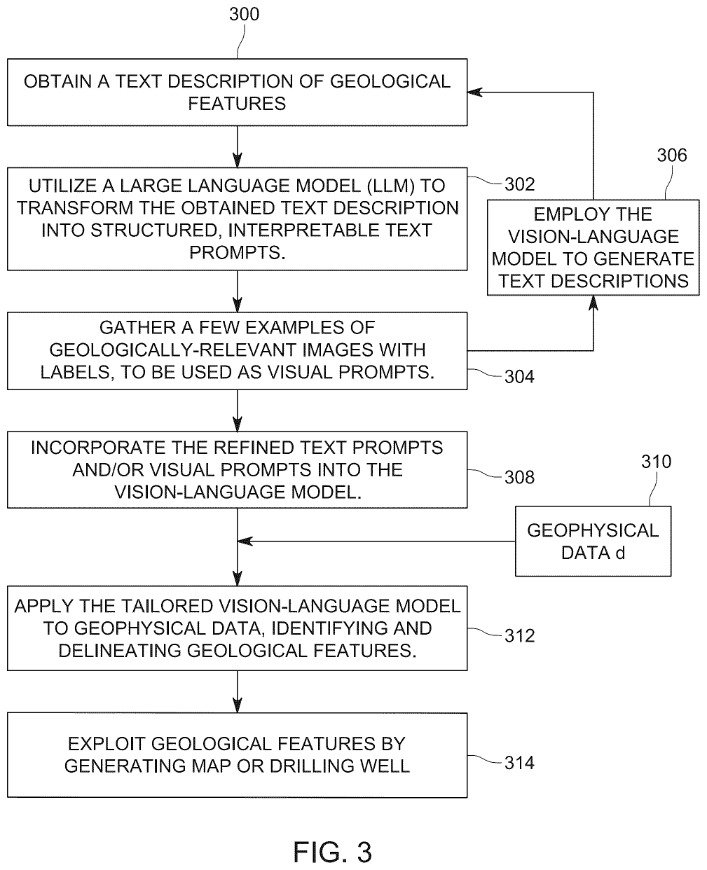

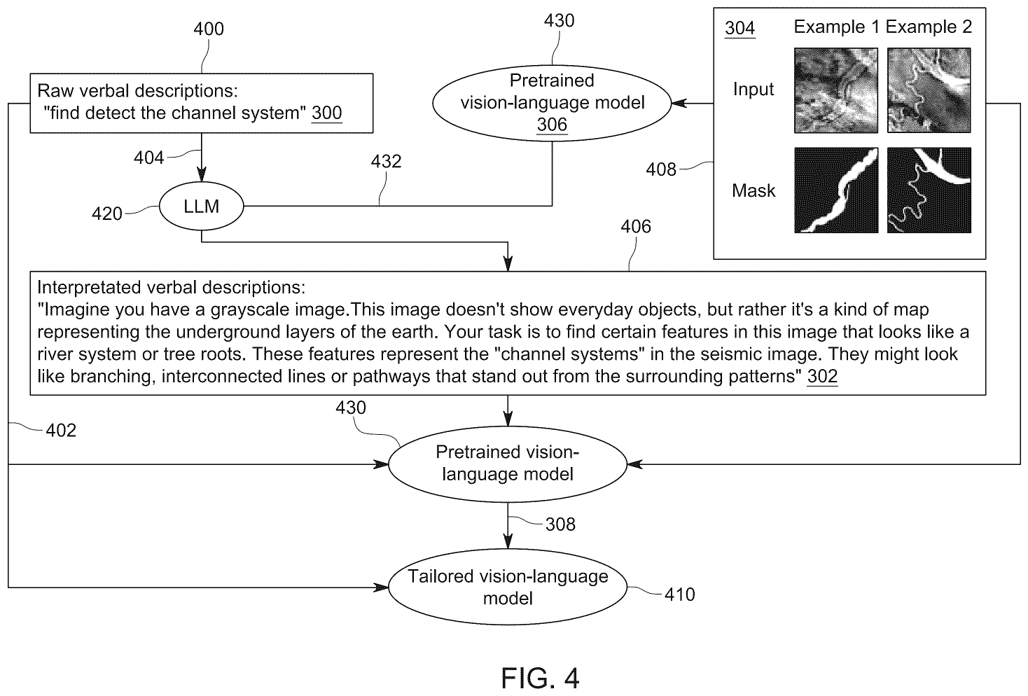

Based on these capabilities of the video-language model, according to an embodiment, a method for determining geological features in recorded seismic data, for a given subsurface, includes a step 300 of obtaining, from a geologist, a text description of one or more geological features, as schematically illustrated in FIG. 3. FIG. 4 illustrates a practical example for the method discussed with regard to FIG. 3. For example, the text description of the geological features may be supplied by the geologist, and may be “detect the channel system.” Note that in oil and gas exploration, a channel system refers to a geological formation or feature that consists of interconnected channels carved by sediment transport processes such as rivers, streams, or submarine currents. These channels can act as conduits for the migration and deposition of sediment, as well as hydrocarbons in the case of petroleum systems. Channel systems are important geological features because they often serve as reservoirs for oil and gas. Sediments deposited within channels can form porous and permeable reservoir rocks that have the potential to trap and accumulate hydrocarbons over geological time scales. As a result, identifying and understanding channel systems is conducive for successful exploration and production activities in the oil and gas industry.

The description provided in step 300 can either be used in step 402 in FIG. 4, as a text prompt 400, to a tailored vision-language model (VLM) 410, or a pretrained VLM 430. The tailored VLM 410 is obtained from the pretrained VLM 430, after being fine-tuned based on geological examples (for example, less than 10 examples) as discussed later. The pretrained VLM 430 is an off the shelf model that was pretrained with images and text unrelated to seismic data or geological features. In one alternative implementation, the text prompt 400 is further refined in step 302. For example, in step 302, the description 400 provided in step 300 is supplied 404 to a Large Language Model (LLM) 420 to transform the supplied text 400 description into structured, interpretable text prompts 406. This step ensures that the prompts 400 are tailored to be more comprehensible to the VLM 410.

In step 304, which is illustrated in both FIGS. 3 and 4, one or more geological relevant images 408 (e.g., Examples 1 and 2 in FIG. 4 showing underground channels in a given subsurface) are collected by the geologist and these examples are used as visual prompts for a pretrained VLM 430 in step 306. After the configuring 308 of the pretrained VLM 430 with the geological images 408 (e.g., less than 10), the tailored VLM 410 is obtained, as schematically illustrated in FIG. 4. The geologically relevant images 408 include images with labels. These images provide a visual context that complements the text prompts, aiding the vision-language model in accurate interpretation. The geological images 408 are taken from the analysis of one or more subsurfaces that are not related to the subsurface of interest. Because of supplying the geological images 408 in step 306, to the pretrained VLM 430, text descriptions are generated 432, which are supplied to the LLM 420 for providing the interpreted verbal descriptions 406.

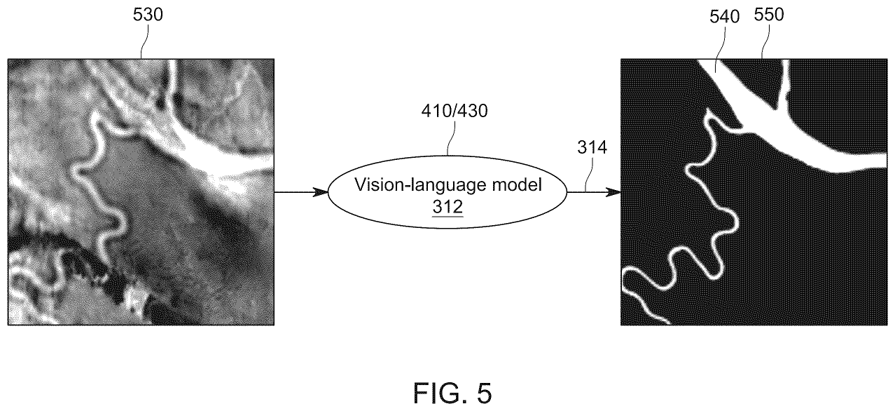

In step 308, the text prompts 406 and/or visual prompts 408 are used with the pretrained VLM 430 to fine-tune or configure the tailored VLM 410. This step customizes the VLM 430 for particular geological interpretation tasks, leveraging both textual and visual information. The configuring of the VLM model is concluded at this point and the model may now be applied to new seismic data d, corresponding to a new subsurface, for geological feature extraction. However, the pretrained VLM 430 may also be used with the new seismic data d for feature extraction. Thus, in step 312 (see FIG. 5), the tailored VLM 410 (or the pretrained VLM 430) is applied to geophysical data 530 (e.g., acquired seismic data d or geophysical image of the subsurface obtained based on the acquired seismic data d), received in step 310, for identifying and delineating geological features 540 through integrated visual prompts and/or text prompts 406/408 (see FIG. 5 for a schematic illustration of these steps).

The determined geological features 540 may be displayed as an image 550, in step 314, and based on this image, a well may be drilled to reach the oil and gas reservoir associated with a geological feature, or another action may take place. Note that in one embodiment, the image 550 is obtained by delineating the geological features 540 onto the input seismic image 530.

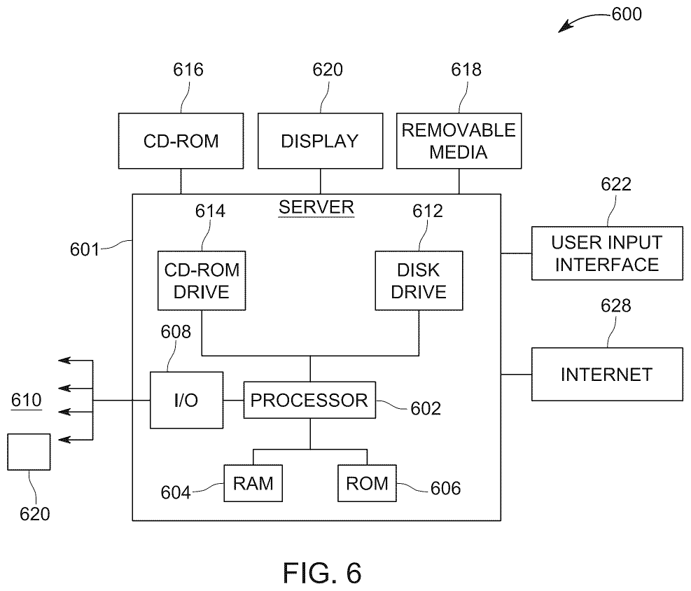

The models and methods discussed above may be implemented in a system 600 as illustrated in FIG. 6. Hardware, firmware, software or a combination thereof may be used to perform the various steps and operations described herein. The computing device 600 is suitable for performing the activities described in the above embodiments and may include a server 601. Such a server 601 may include a central processor (CPU) 602 coupled to a random access memory (RAM) 604 and to a read-only memory (ROM) 606. ROM 606 may also be other types of storage media to store programs, such as programmable ROM (PROM), erasable PROM (EPROM), etc. Processor 602 may communicate with other internal and external components through input/output (I/O) circuitry 608 and bussing 610 to provide control signals and the like. Processor 602 carries out a variety of functions as are known in the art, as dictated by software and/or firmware instructions.

Server 601 may also include one or more data storage devices, including hard drives 612, CD-ROM drives 614 and other hardware capable of reading and/or storing information, such as DVD, etc. In one embodiment, software for carrying out the above-discussed steps may be stored and distributed on a CD-ROM or DVD 616, a USB storage device 618 or other form of media capable of portably storing information. These storage media may be inserted into, and read by, devices such as CD-ROM drive 614, disk drive 612, etc. Server 601 may be coupled to a display 620, which may be any type of known display or presentation screen, such as LCD, plasma display, cathode ray tube (CRT), etc. A user input interface 622 is provided, including one or more user interface mechanisms such as a mouse, keyboard, microphone, touchpad, touch screen, voice-recognition system, etc.

The server may be part of a larger network configuration as in a global area network (GAN) such as the Internet 628, which allows ultimate connection to various landline and/or mobile computing devices.

As described above, the apparatus 600 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 602 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally, or alternatively, the processor may include one or more processors configured in tandem via the bus to enable independent execution of instructions, pipelining and/or multithreading.

In an example embodiment, the processor 602 may be configured to execute instructions stored in the memory device 604 or otherwise accessible to the processor. Alternatively, or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

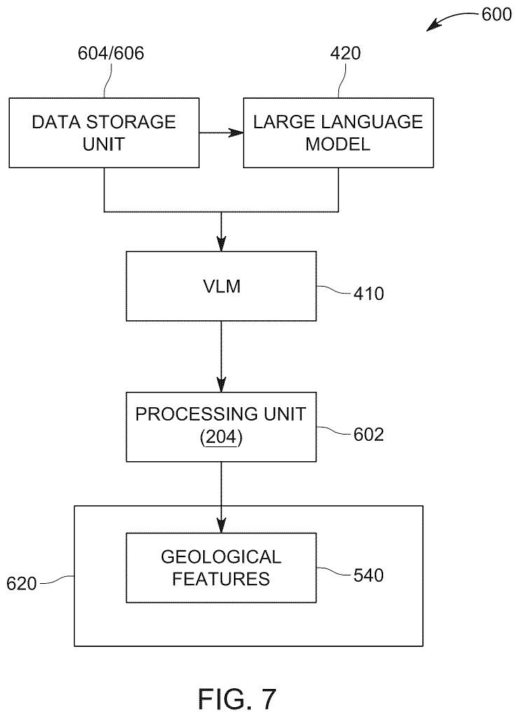

The system illustrated in FIG. 6 may be configured so that the data storage unit 604/606 stores the verbal and/or written descriptions of geological features 400/406 and the 3D seismic data d, as illustrated in FIG. 7. The data storage unit 604/606 interacts with the LLM 420, which is configured to convert the verbal and/or written descriptions 400/406 into interpretable input. The pretrained VLM 430 may be hosted by the processor 602 and is configured to receive the interpreted examples. Processor 602 is also configured to process the 3D seismic data d using the VLM 410 and detect the geological features 540, which are then displayed on the monitor 620.

According to an embodiment, the pretrained VLM 430 may be the Vision Transformer (ViT), or its variants, known as CLIP, BLIP, etc. The LLM 420 used for processing verbal and/or written descriptions may be GPT-3, GPT-4, Llama, or any other suitable language model. As all these models are known in the art, their description is omitted herein.

The input data d used in step 310 was assumed to be 3-dimensional (3D) seismic data. This data may be augmented by 2D seismic data or well log data, to complement the 3D seismic data and improve the detection and delineation of the geological features. This change of the input data could enable a more comprehensive analysis of subsurface structures and help geoscientists better understand the Earth's composition.

A further embodiment could involve integrating the geological interpretation system 600 with other geoscience tools, such as reservoir modelling software, petrophysical analysis tools, or geomechanical simulators. This would allow for seamless interaction between the geological interpretation results and other aspects of subsurface analysis, leading to more accurate and efficient decision-making.

In yet another embodiment, the system 600 could be extended to include a model pre-training or finetuning component, where the pretrained VLM 430 and the LLM 420 iteratively refine their predictions based on feedback from domain experts. This would enable the system 600 to adapt more effectively to new datasets and improve its performance over time.

Furthermore, the present embodiments could also be applied to other domains beyond geological interpretation. For example, the vision-language model and large language model could be utilized for the interpretation of medical images, remote sensing data, or any other application where image analysis and feature detection are required.

Thus, the present embodiments provide a system 600 and method for geological interpretation of 3D seismic data using VLM, LLM, and minimal supervision. By leveraging textual descriptions of geological features and/or small number of labelled data examples, the system can efficiently and accurately detect and delineate geological features in 3D seismic data, reducing the need for extensive human input and facilitating more objective interpretation results. This novel approach enables geoscientists and other domain experts to better understand subsurface structures and make more informed decisions related to exploration, drilling, and reservoir management.

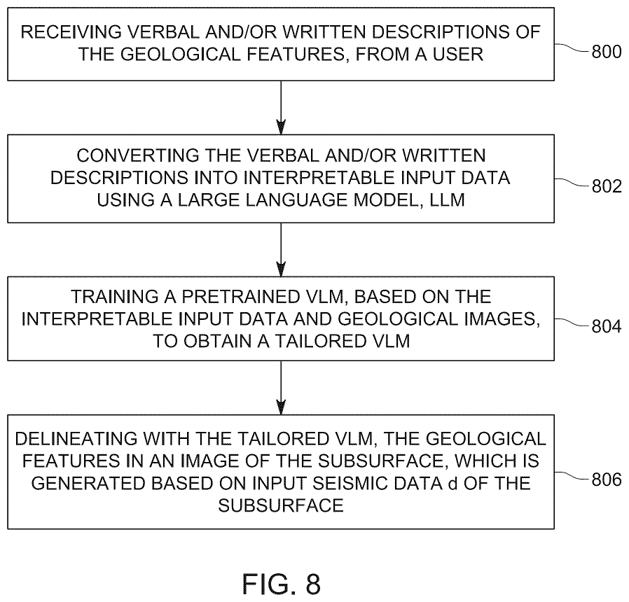

A method for generating geological features of a surveyed subsurface with a vision-language model, VLM, based on one or more of the embodiments discussed above is illustrated in FIG. 8. The method includes a step 800 of receiving verbal and/or written descriptions of the geological features, from a user, a step 802 of converting the verbal and/or written descriptions into interpretable input data using a large language model, LLM, a step 804 of configuring (or customizing) a pretrained VLM, based on the interpretable input data and geological images, to obtain a tailored VLM, and a step of delineating with the tailored VLM, the geological features in an image of the subsurface, which is generated based on input seismic data d of the subsurface.

In one application, the geological features include a channel or a fault in the subsurface, and the interpretable input data includes text descriptions of the geological features. The tailored VLM is configured to take text prompts and visual prompts as input, where the text prompts describe the visual prompts. The pretrained VLM is pretrained based on plural images unrelated to the input seismic data d or the geological images. The geological images are not related to the subsurface.

The method may further include a model fine-tuning stage, which utilizes a relatively small number of geological images to fine-tune the pretrained VLM to become the tailored VLM. The LLM is a generative pre-trained transformer model (GPT).

Not all the steps illustrated in FIG. 8 need to be performed for extracting the geological features. For example, according to another embodiment, the method includes only the step 800 of receiving verbal and/or written descriptions of the geological features, from a user, and the step 806 of delineating with a tailored VLM, the geological features in a seismic image of the subsurface, generated based on input seismic data d of the subsurface.

The methods discussed herein may be applied not only to the field of subsurface exploration, for example, hydrocarbon exploration and development, geothermal exploration and development, and carbon capture and sequestration, or other natural resource exploration and exploitation. They could also be employed for surveying and monitoring for windfarm applications, both onshore and offshore, and also for medical imaging applications.

The term “about” is used in this application to mean a variation of up to 20% of the parameter characterized by this term. It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

The disclosed embodiments provide a pretrained or tailored VLM for determining a geologic body or feature in seismic data associated with a subsurface. It should be understood that this description is not intended to limit the invention. On the contrary, the embodiments are intended to cover alternatives, modifications, and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for delineating geological features of a surveyed subsurface with a vision-language model, VLM, the method comprising:
receiving verbal and/or written descriptions of the geological features, from a user;
converting the verbal and/or written descriptions into interpretable input data using a large language model, LLM;
configuring a pretrained VLM, based on the interpretable input data and geological images of another subsurface, to obtain a tailored VLM; and
delineating with the tailored VLM, the geological features in an image of the subsurface, which is generated based on input seismic data d acquired over the subsurface.

2. The method of claim 1, wherein the geological features include a channel or a fault in the subsurface.

3. The method of claim 1, wherein the interpretable input data includes text descriptions of the geological features.

4. The method of claim 1, wherein the tailored VLM is configured to take as input text prompts and visual prompts, where the text prompts describe the visual prompts.

5. The method of claim 1, wherein the pretrained VLM is pretrained based on plural images unrelated to the input seismic data d, the geological images, the subsurface, or the another subsurface.

6. The method of claim 1, wherein the geological images are related to the another subsurface.

7. The method of claim 1, wherein the pretrained VLM detects and delineates the geological features without any prior geological images.

8. The method of claim 1, wherein a small number of geological images of the another subsurface is used to fine-tune the pretrained VLM to become the tailored VLM.

9. The method of claim 1, wherein the LLM is a generative pre-trained transformer model (GPT).

10. A method for delineating geological features of a surveyed subsurface, with a vision-language model, VLM, the method comprising:
receiving verbal and/or written descriptions of the geological features, from a user; and
delineating with a tailored VLM or a pretrained VLM, the geological features in a seismic image of the subsurface, generated based on input seismic data d of the subsurface.

11. The method of claim 10, further comprising:
converting the verbal and/or written descriptions into interpretable input data using a large language model, LLM; and
configuring the pretrained VLM, based on the interpretable input data and geological images of another subsurface, to obtain the tailored VLM.

12. The method of claim 10, wherein the geological features include a channel or a fault in the subsurface.

13. The method of claim 10, wherein the tailored and pretrained VLMs are configured to take text prompts and visual prompts as input, where the text prompts describe one or more features of the visual prompts.

14. The method of claim 11, wherein the pretrained VLM is pretrained based on plural images unrelated to the input seismic data d, the geological features, the subsurface, or the another subsurface.

15. The method of claim 10, wherein the geological images are related to another subsurface.

16. The method of claim 10, wherein the pretrained VLM detects and delineates the geological features without any prior geological images.

17. The method of claim 10, wherein a small number of geological images of the another subsurface is used to fine-tune the pretrained VLM to become the tailored VLM.

18. A device for detecting geological features associated with seismic data d, the device comprising:
a processor implementing a pretrained visual-language model, VLM, or a tailored VLM, which is trained with verbal and/or written descriptions and geological images associated with a first subsurface, which not associated with the seismic data d; and
an interface connected to the processor and configured to receive the seismic data d, which is associated with a second subsurface,
wherein the processor is configured to,
receive verbal and/or written descriptions of the geological features, from a user; and
delineate with the tailored VLM or the pretrained VLM, the geological features in an image of the second subsurface, based on the seismic data d acquired over the second subsurface.

19. The method of claim 18, wherein the processor is further configured to:
convert the verbal and/or written descriptions into interpretable input data using a large language model, LLM; and
configure the pretrained VLM, based on the interpretable input data and geological images, to obtain the tailored VLM.

20. The method of claim 18, wherein the tailored and pretrained VLMs are configured to take text prompts and visual prompts as input, where the text prompts describe one or more features of the visual prompts.
